(19) United States
(12) Patent Application Publication
(10) Pub. No.: US 2026/0329913 A1
(43) Pub. Date: Oct. 22, 2026

(54) OUT-OF-DISTRIBUTION VECTOR RETRIEVAL METHOD AND DEVICE

(71) Applicant: Hangzhou Dianzi University, Hangzhou City (CN)

(72) Inventors: Xiaoliang XU, Hangzhou City (CN); Qiang YUE, Hangzhou City (CN)

(21) Appl. No.: 19/331,761

(22) Filed: Sep. 17, 2025

(30) Foreign Application Priority Data
Apr. 22, 2025 (CN) 202510505842.0

(51) Int. Cl. G06F 16/334; G06F 16/338; G06F 18/25

(52) U.S. Cl. CPC G06F 16/3347; G06F 16/338; G06F 18/251

(57) ABSTRACT

An out-of-distribution vector retrieval method and device are provided. According to the method, a corresponding anchor vector is first constructed for each base vector in a base vector set based on a query vector set, and a fusion graph is constructed based on the base vector and the anchor vector. A vector to be queried is searched by using the fusion graph, so as to obtain a result similar to the vector to be queried.

### CROSS-REFERENCE TO RELATED APPLICATION

This application claims the benefit of and priority to Chinese Patent Application No. 202510505842.0, filed Apr. 22, 2025, which is hereby incorporated by reference herein in its entirety.

### TECHNICAL FIELD

The present disclosure relates to the field of vector retrieval, and in particular, to an out-of-distribution vector retrieval method and device.

### BACKGROUND

Vector retrieval is a basic module for many modern applications (for example, a search engine, a large language model, and a recommendation system). A vector retrieval algorithm provides a good balance between search delay and accuracy for a search phase by constructing an index that can describe a similarity relationship of base vectors in a base vector set.

However, the existing theory on which vector retrieval depends has an implicit premise that a query vector set and a base vector set have the same distribution (that is, the query vector set is in-distribution data). When the query vector set and the base vector set have different distributions (that is, the query vector set is out-of-distribution data), the performance of an out-of-distribution query is lower than that of an in-distribution query by an order of magnitude or more. Taking an image library of a search engine as an example, when a user inputs an image as a query, the query is an in-distribution query, and when the user inputs text as a query, the query is an out-of-distribution query. Due to the problem of the out-of-distribution query in vector retrieval, it takes longer for the user to obtain a result when searching for an image by text, and the search result is inaccurate. This is mainly due to lack of clustering of neighbors in the out-of-distribution query, that is, neighbors in the out-of-distribution query are probably not neighbors. To resolve the problems of slow speed and poor accuracy of the search engine in searching for an image by text, the existing researches have proposed out-of-distribution vector retrieval algorithms, such as RoarGraph and RobustVamana, in which connected edges are added between the nearest neighbors of a sampled query vector set (usually 10% of the base vector set) to enhance clustering of graph indexes. However, this method can only optimize some nodes of graph indexes, and most nodes are still not optimized for out-of-distribution queries. Therefore, a search engine based on this algorithm can only gain limited performance improvement when searching for the image by text. In view of the above problems, the present disclosure provides a novel vector retrieval method for out-of-distribution queries after comprehensively considering neighbor relationships among nodes in a graph index under distribution of a base vector set and distribution of a query vector set.

### SUMMARY

In view of the above problems, the present disclosure provides an out-of-distribution vector retrieval method and device, in which a fusion graph is constructed based on a neighbor relationship between a base vector set and a query vector set that follow different distributions to implement a retrieval task. Compared with the existing algorithms, the method can better adapt to an out-of-distribution vector retrieval task, thereby improving search accuracy and search efficiency.

To achieve the above objective, the present disclosure adopts the following technical solutions.

An out-of-distribution vector retrieval method includes the following steps:
step (1), obtaining a base vector set and a query vector set, where the query vector set is out-of-distribution data relative to the base vector set;
step (2), finding several nearest query vectors within the query vector set for each base vector within the base vector set, and generating an anchor vector for each base vector based on the found query vectors, where all anchor vectors constitute an anchor vector set;
step (3), constructing a fusion graph based on the base vector set and the anchor vector set; and
step (4), obtaining and converting a query text entered by a user from a search engine into a to-be-queried vector, performing search on the fusion graph to obtain a base vector similar to the to-be-queried vector, and returning the obtained base vector as a query result.

In some embodiments, in step (1), the query vector set being the out-of-distribution data relative to the base vector set is defined as follows:

step (1-1), with the obtained base vector set X={x₁, . . . , x_{N}} containing N independent and identically distributed base vectors and the query vector set Q={q₁, . . . , q_{M}} containing M independent and identically distributed query vectors, for a query vector q as any one of the query vector set Q, denoting a set of K neighbors of the query vector q in the base vector set X as

$$R ( q ) = \{ {x}_{1}^{q} , … , {x}_{i}^{q} , … , {x}_{K}^{q} \} , where {x}_{i}^{q}$$

is the i-th neighbor of q, and

$${x}_{1}^{q}$$

is the nearest neighbor of q. For the nearest neighbor

$${x}_{1}^{q}$$

of the query vector q, a set of K neighbors of the nearest neighbor

$${x}_{1}^{q}$$

in the base vector set X is denoted as

$$R ( {x}_{1}^{q} ) = \{ {x}_{1}^{n} , … , {x}_{i}^{n} , … , {x}_{K}^{n} \} ,$$

where

$${x}_{i}^{n}$$

is the i-th neighbor of

$${x}_{1}^{q} .$$

Neighborhood alignment quality NAQ(q) of the query vector q with respect to the base vector set X is defined as:

$$NAQ ( q ) = \frac{( R ( q ) ∖ \{ {x}_{1}^{q} \} ) ⋂ ( R ( {x}_{1}^{q} ) ∖ \{ {x}_{1}^{n} \} )}{K - 1} ,$$

and
neighborhood alignment quality NAQ of the query vector set Q with respect to the base vector set X is defined as:

$$NAQ = \frac{1}{M} {\sum }_{i = 1}^{M} NAQ ( {q}_{i} ) .$$

step (1-2), in response to the neighborhood alignment quality NAQ being less than a predetermined constant η, where 0<η≤1, indicating that the query vector set Q is the out-of-distribution data relative to the base vector set X, otherwise, indicating that the query vector set Q is in-distribution data.

In some embodiments, in step (2), a process of constructing the anchor vector set includes:
step (2-1), for any base vector x of the base vector set X={x₁, . . . , x_{N}}, obtaining a set of C query neighbors of x in the query vector set Q as

$$G T ( x ) = \{ {q}_{1}^{x} , … , {q}_{C}^{x} \} ,$$

where C is the number of query neighbors required for constructing the anchor vector set; and
step (2-2), inputting the query neighbor set GT(x) corresponding to each base vector x into an aggregation function e(·) to obtain an anchor vector τ, where all anchor vectors constitute the anchor vector set T.

In some embodiments, in step (3), a process of constructing the fusion graph includes:
step (3-1), constructing, based on the base vector set X, a base neighbor graph G*(V, E*) with a first out-degree upper limit of L, where each node v of V represents a base vector x, E* indicates a neighbor relationship between nodes; and for any two nodes vᵢ and vⱼ in the base neighbor graph G*(V, E*), evaluating a similarity between vᵢ and vⱼ by using a distance δ(xᵢ, xⱼ), where xᵢ is a base vector corresponding to the node vᵢ, and xⱼ is a base vector corresponding to the node vⱼ;
step (3-2), for each node v of the base neighbor graph G*(V, E*), obtaining a base neighbor N*(v) of the node v in G*(V, E*) as a candidate and reranking, wherein
the base neighbor N*(v) is a set of end points of directed edges with the node v as a starting point in G*(V, E*); and
the reranking includes: for the node v and any one node vᵢ∈N*(v) of the base neighbor N*(v), evaluating a similarity between vᵢ and v by using a fusion distance δ_{f} (vᵢ, v)=δ(xᵢ+ατᵢ, x+ατ) during the reranking, where a is a fusion weight parameter, x and τ respectively are a base vector and an anchor vector corresponding to the node v, and xᵢ and τᵢ respectively are a base vector and an anchor vector corresponding to the node vᵢ; and
step (3-3), setting a second out-degree upper limit R, where R<L, for each node v, performing similarity ranking according to a fusion distance from the base neighbor N*(v), selecting nodes v* in a descending order according to similarity to attempt to establish edges, and establishing the edges when the nodes v* meet an occlusion rule, and stopping the selecting and the establishing the edges when the number of established edges is equal to R, to obtain a fusion neighbor N(v); and
obtaining the fusion graph G(V, E) after for all nodes in G*(V, E*), edges are established according to the occlusion rule, where
N(v) is a set of end points of directed edges with the node v as a starting point in the fusion graph G(V, E).

In some embodiments, in step (4), the performing search on the fusion graph to obtain the base vector similar to the to-be-queried vector includes:
step (4-1), selecting P nodes from the fusion graph G(V, E) as entry points, and placing the P nodes in a candidate set H;
step (4-2), selecting a node v∈H that is not accessed and is nearest to the to-be-queried vector q* from the candidate set H as a current access node, evaluating a distance between v and q* by using a distance δ(x, q*), and placing a fusion neighbor N(v) of the current access node in the candidate set H, where x is a base vector corresponding to the current access node v;
where the to-be-queried vector q* and the query vector set Q are independent and identically distributed;
step (4-3), evaluating a similarity between any one node v of the candidate set H and q* by using the distance δ(x, q*), performing similarity ranking in a descending order on all nodes of the candidate set H based on the distance δ(x, q*), and deleting nodes with ranks greater than P from the candidate set H, where x is a base vector corresponding to the node v; and
step (4-4), repeating step (4-2) to step (4-3) until there is no node that is not accessed in the candidate set H, and selecting the first k base vectors from the candidate set H as a result.

In some embodiments, the base vector set in step (1) is composed of vectors obtained by converting pictures or videos in an image library of the search engine, and the query vector set is composed of vectors obtained by converting the query text entered by the user from the search engine;
step (4) further includes:
outputting, based on the base vector obtained in step (4), a picture or a video in the image library of the search engine corresponding to the base vector.

In some embodiments, in the distance δ(xᵢ, xⱼ) and the fusion distance of δ_{f}(vᵢ, v)=δ(xᵢ+ατᵢ, x+ατ), δ is any one of the following three distance metrics: Euclidean distance, cosine similarity, and an inner product.

The present disclosure further provides an out-of-distribution vector retrieval device, configured to implement the out-of-distribution vector retrieval method, the retrieval device including:
an input module, configured to obtain the base vector set and the query vector set as an input, where the query vector set is the out-of-distribution data relative to the base vector set;
an anchor vector set construction module, configured to find several nearest query vectors within the query vector set for each base vector within the base vector set, and generate the anchor vector for each base vector based on the found query vectors, where all anchor vectors constitute the anchor vector set;
a fusion graph construction module, configured to construct the fusion graph based on the base vector set and the anchor vector set; and
a search result output module, configured to perform search on the fusion graph to obtain the base vector similar to the to-be-queried vector, and return the obtained base vector as the query result.

In some embodiments, the input module includes: a base vector set input module, configured to obtain the base vector set; a query vector set input module, configured to obtain the query vector set; and a query distribution difference discrimination module, configured to determine whether the query vector set is the out-of-distribution data or in-distribution data.

According to the out-of-distribution vector retrieval method provided in the present disclosure, a fusion graph is constructed based on the neighbor relationship between the base vector set and the query vector set that follow different distribution, and a similarity relationship between the base vector set and the query vector set is comprehensively considered, thereby better adapting to an out-of-distribution vector retrieval task, and improving search accuracy and search efficiency.

With the present disclosure, taking an application in which a search engine searches an image by text as an example, after the text description is entered by a user, an image or a video that is more relevant to the text description in an image library may be obtained with the same search delay, for example, the user searches to obtain k results with a higher recall rate. In addition, the search engine that uses the present disclosure can effectively improve throughput, for example, a search engine system has higher queries per second.

### BRIEF DESCRIPTION OF DRAWINGS

FIG. 1 is a schematic flowchart according to the present disclosure;

FIG. 2A is a first graph showing benchmark test results with recall rate @ 100 and queries per second under Text-to-Image according to the present disclosure;

FIG. 2B is a second graph showing benchmark test results with recall rate @100 and queries per second under LAION according to the present disclosure;

FIG. 2C is a third graph showing benchmark test results with recall rate @ 100 and queries per second under CC3M according to the present disclosure;

FIG. 2D is a fourth graph showing benchmark test results with recall rate @ 100 and queries per second under Web Vid according to the present disclosure;

FIG. 2E is a fifth graph showing benchmark test results with recall rate @ 100 and queries per second under WIT according to the present disclosure;

FIG. 3A is a sixth graph showing benchmark test results with recall rate @ 100 and the number of distance calculations under Text-to-Image according to the present disclosure;

FIG. 3B is a seventh graph showing benchmark test results with recall rate @100 and the number of distance calculations under LAION according to the present disclosure;

FIG. 3C is an eighth graph showing benchmark test results with recall rate @100 and the number of distance calculations under CC3M according to the present disclosure;

FIG. 3D is a ninth graph showing benchmark test results with recall rate @ 100 and the number of distance calculations under Web Vid according to the present disclosure;

FIG. 3E is a tenth graph showing benchmark test results with recall rate @ 100 and the number of distance calculations under WIT according to the present disclosure;

FIG. 4A is a eleventh graph showing benchmark test results with recall rate @10 and queries per second under Text-to-Image according to the present disclosure;

FIG. 4B is a twelfth graph showing benchmark test results with recall rate @ 10 and queries per second under LAION according to the present disclosure;

FIG. 4C is a thirteenth graph showing benchmark test results with recall rate @10 and queries per second under CC3M according to the present disclosure;

FIG. 4D is a fourteenth graph showing benchmark test results with recall rate @ 10 and queries per second under WebVid according to the present disclosure;

FIG. 4E is a fifteenth graph showing benchmark test results with recall rate @10 and queries per second under WIT according to the present disclosure;

FIG. 5A is a sixteenth graph showing benchmark test results with recall rate @10 and the number of distance calculations under Text-to-Image according to the present disclosure;

FIG. 5B is a seventeenth graph showing benchmark test results with recall rate @ 10 and the number of distance calculations under LAION according to the present disclosure;

FIG. 5C is a eighteenth graph showing benchmark test results with recall rate @10 and the number of distance calculations under CC3M according to the present disclosure;

FIG. 5D is a nineteenth graph showing benchmark test results with recall rate @10 and the number of distance calculations under WebVid according to the present disclosure; and

FIG. 5E is a twentieth graph showing benchmark test results with recall rate @10 and the number of distance calculations under WIT according to the present disclosure.

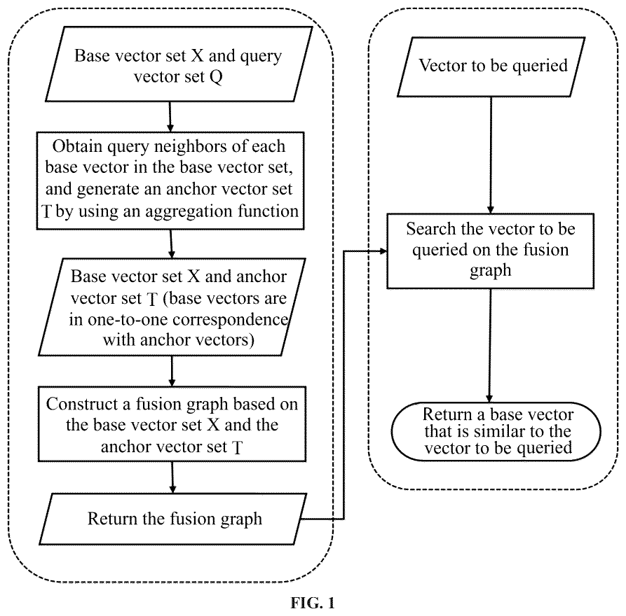

### DESCRIPTION OF EMBODIMENTS

To enable those of ordinary skill in the art to better understand the technical solutions of the present disclosure, the technical solutions of the present disclosure will be further described with reference to the accompanying drawings and embodiments.

(1) First, an original database and an original query set are obtained. In this embodiment, the original database is video data, and the original query set is text data.

(2) A base vector set and a query vector set are generated, the base vector set is generated from the original database by using a UniterVideo network model, and the query vector set is generated from the original query set by using a Transformer network model. Specifically, the base vector set X={x₁, . . . , x_{N}} contains N independent and identically distributed base vectors, and the query vector set Q={q₁, . . . , q_{M}} contains M independent and identically distributed query vectors. A set of K neighbors of a query vector q in the base vector set X is

$$R ( q ) = \{ {x}_{1}^{q} , … , {x}_{i}^{q} , … , {x}_{K}^{q} \} , where {x}_{i}^{q}$$

is the i-th neighbor of q, and

$${x}_{1}^{q}$$

is the nearest neighbor or q. A set of K neighbors of the nearest neighbor

$${x}_{1}^{q}$$

$$R ( {x}_{1}^{q} ) = \{ {x}_{1}^{n} , … , {x}_{i}^{n} , … , {x}_{K}^{n} \} , where {x}_{i}^{n}$$

is the i-th neighbor of

$${x}_{1}^{q} ,$$

and the query vector set Q satisfies the following condition with respect to the base vector set X:

$$NAQ < η , NAQ = \frac{1}{M} {\sum }_{i = 1}^{M} NAQ ( {q}_{i} ) ,$$

where, NAQ (q) is defined as:

$$NAQ ( q ) = \frac{( R ( q ) ∖ \{ {x}_{1}^{q} \} ) ⋂ ( R ( {x}_{1}^{q} ) ∖ \{ {x}_{1}^{n} \} )}{K - 1} .$$

In some embodiments, η is set as follows: a data set X* with the same distribution as the base vector set is obtained, its NAQ with respect to the base vector set X is calculated, and the calculated NAQ is used as η.

(3) For any base vector x of the base vector set X={x₁, . . . , x_{N}}, a set of C query neighbors of x in Q is obtained as

$$GT ( x ) = \{ {q}_{1}^{x} , … , {q}_{C}^{x} \} ,$$

where C is a parameter to be determined according to a given base vector set and a query vector set. For the query neighbor set GT(x) corresponding to each base vector x, it is input into an aggregation function e(·), and an anchor vector t is output, where a set of anchor vectors constitute an anchor vector set T.

(4) In some embodiments, the aggregation function

$$e ( G T ( x ) ) = \frac{1}{C} {\sum }_{i = 1}^{c} {q}_{i}^{x} .$$

(5) A base neighbor graph G*(V, E*) is constructed based on the base vector set X, where each node v of V represents a base vector x, E* indicates a neighbor relationship between nodes, and for any two nodes vᵢ and vⱼ in the base neighbor graph G*(V, E*), a distance δδ(xᵢ, xⱼ) is used as a similarity metric, where an out-degree upper limit of the base neighbor graph is L, xᵢ is a base vector corresponding to the node vᵢ, and xⱼ is a base vector corresponding to the node vⱼ.

(6) For each node v of the base neighbor graph G*(V, E*), a base neighbor N*(v) of the node v in G*(V, E*) is obtained as a candidate and reranked, where N*(v) is a set of end points of directed edges with the node v as a starting point in G*(V, E*). Specifically, for the node v and any one node vᵢ∈N*(v) of the base neighbor N*(v), N*(v) is reranked by using a fusion distance δ_{f}(vᵢ, v)=δ(xᵢ+ατᵢ, x+ατ) as a new similarity metric, where a is a fusion weight parameter, x and τ respectively are a base vector and an anchor vector corresponding to the node v, and xᵢ and τᵢ respectively are a base vector and an anchor vector corresponding to the node vᵢ. The fusion distance enables each node in the graph index to comprehensively represent a neighbor relationship under the distribution of the base vector set and the query vector set by distance. For example, for two nodes that are similar under the distribution of base vectors, δ_{f}(vᵢ, v)≈αδ_{f}(τᵢ, τ). In this case, the fusion distance supports further consideration of a neighbor relationship under the distribution of the query vector set, which enhances the clustering of query neighbors. On the contrary, for two nodes that are similar under the distribution of the query vector set, δ_{f}(vᵢ, v)≈δ_{f}(xᵢ, x), thereby ensuring that the nodes maintain a basic neighbor relationship.

(7) In some embodiments, the parameter C and the fusion weight parameter a are obtained by the following method: for a fusion vector set Z={z₁, . . . , z_{N}}, a fusion vector is

$$z = x + ατ , where τ = \frac{1}{C} {\sum }_{i = 1}^{c} {q}_{i}^{x} .$$

The parameter C and the fusion weight parameter a satisfy that the query vector set Q has maximum neighborhood alignment quality NAQ with respect to the fusion vector set Z.

(8) In some embodiments, an out-degree upper limit R (R<L) is set, which is the out-degree upper limit of the fusion graph G(V, E). For each node v, a node v* with the minimum fusion distance of δ_{f}(v, v*) is selected from the base neighbor N*(v) to attempt to connect edges. When the node v* meets an occlusion rule of a neighbor graph (for example, a navigation spreading-out graph (NSG)) algorithm: ∀v′∈N*(v), δ_{f}(v′, v*)>δ_{f}(v′, v), an edge is established between v and v*, a fusion neighbor N(v)←N(v)∪{v*} is updated, and a candidate N*(v)←N*(v)\{v*} is updated, where N(v) is a set of end points of directed edges with the node v as a starting point in the fusion graph G(V, E). Edges are reestablished based on the occlusion rule, so that neighbors of each node are distributed in different directions, thereby avoiding the situation that a search process cannot converge quickly due to excessive concentration of neighbors.

(9) Step (8) is repeated until the number of established edges is equal to R, and selecting and edge establishing are stopped to obtain new neighbors N(v), thereby generating a fusion graph G(V, E).

(10) P nodes are selected from the fusion graph G(V, E) as entry points, and placed into a candidate set H, where the candidate set H has a size of P.

(11) A node v E H that is not accessed and is nearest to the vector q to be queried is selected from the candidate set H as a current access node, with a distance metric of δ(x, q), and a fusion neighbor N(v) of the current access node is placed in the candidate, where x is a base vector corresponding to the current access node v.

(12) The candidate set H is ranked in an ascending order, nodes with ranks greater than P are deleted from the candidate set, and for any node v of the candidate set H, δ(x, q) is used as a distance metric during the ranking, where x is a base vector corresponding to the node v.

(13) (11) to (12) are repeated until there is no node that is not accessed in the candidate set H, and select the first k base vectors from the candidate set H as a result.

The present disclosure further provides an out-of-distribution vector retrieval device, configured to implement the out-of-distribution vector retrieval method, the retrieval device including:
an input module, configured to obtain a base vector set and a query vector set as an input, where the query vector set is out-of-distribution data relative to the base vector set;
an anchor vector set construction module, configured to find several nearest query vectors within the query vector set for each base vector within the base vector set, and generate an anchor vector for each base vector based on the found query vectors, where all anchor vectors constitute an anchor vector set; a fusion graph construction module, configured to construct a fusion graph based on the base vector set and the anchor vector set; and
a search result output module, configured to perform search on the fusion graph to obtain a base vector similar to the vector to be queried, and return the obtained base vector as a query result.

In some embodiments, the input module includes: a base vector set input module, configured to obtain the base vector set; a query vector set input module, configured to obtain the query vector set; and a query distribution difference discrimination module, configured to determine whether the query vector set is out-of-distribution data or in-distribution data.

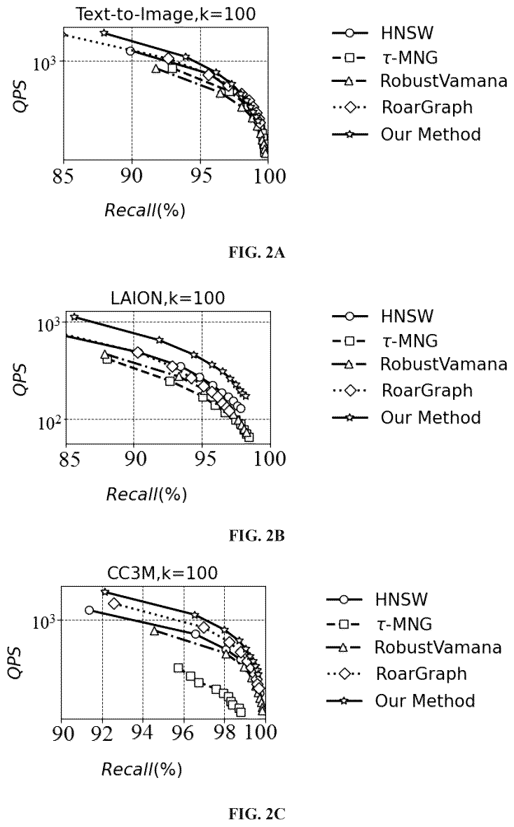

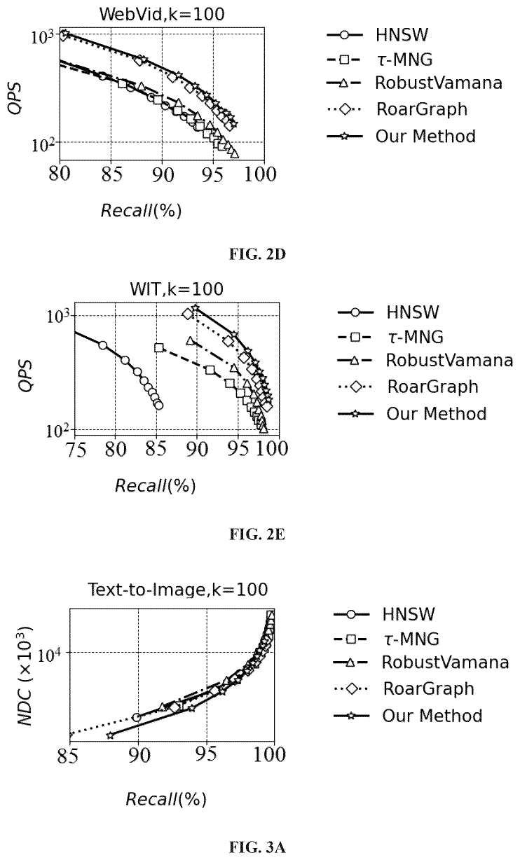

(14) To illustrate effectiveness and efficiency of the present disclosure, benchmark test results are shown in FIGS. 2A-5E. Test data, baseline algorithms, test environment, and test results involved in the test are described as follows.

Test data in this test, five commonly used out-of-distribution data sets (Text-to-Image, LAION, Wikipedia-based Image Text (WIT), Web Vid, and Conceptual Captions 3M (CC3M)) are used for benchmarking. The five out-of-distribution data sets are introduced as follows. Text-to-Image is an out-of-distribution data set from a visual search engine. A base vector set is composed of image vectors generated by a Se-ResNext-101 model, a query vector set is composed of text vectors extracted by a variant using a Deep Structured Semantic Model (DSSM) from user-specified text queries, and an inner product is used as a distance metric. LAION is a widely used text-image data set. Both a base vector set and a query vector set are embedded by using CLIP-ViT-B/3, and cosine similarity is used as a metric. WIT is a data set derived from a text-image application. Text-image pairs are extracted from Wikipedia pages. A base vector set is encoded by using CLIP-ViT-B/32, a query vector set is generated by using CLIP-ViT-B32-multilingual-v1, and cosine similarity is used as a metric. WebVid is a subtitle-video data set from a material website. Data is encoded by using CLIP-ViT-B/32, and cosine similarity is used as a distance metric. CC3M is a text-image pair data set specifically designed for a subtitle-image system. Base vectors are encoded by using ViT-B/16, additional text is converted into query vectors by using BERT, and cosine similarity is used as a metric.

Baseline algorithms: The present disclosure is compared with four advanced graph indexing algorithms in the benchmark test, Hierarchical Navigable Small World (HNSW) and τ-Monotonic Neighborhood Graph (MNG) are in-distribution graph indexing algorithms, and RoarGraph and RobustVamana are out-of-distribution graph indexing algorithms.

Test environment: All tests were conducted on an Ubuntu 20.04 server equipped with Intel (R) Xeon (R) Gold 5218 CPU (2.30 GHz) and 125 GB memory. Matrix operations were enhanced by using an Eigen library, and indexes are built in parallel by using OpenMP with 20 threads.

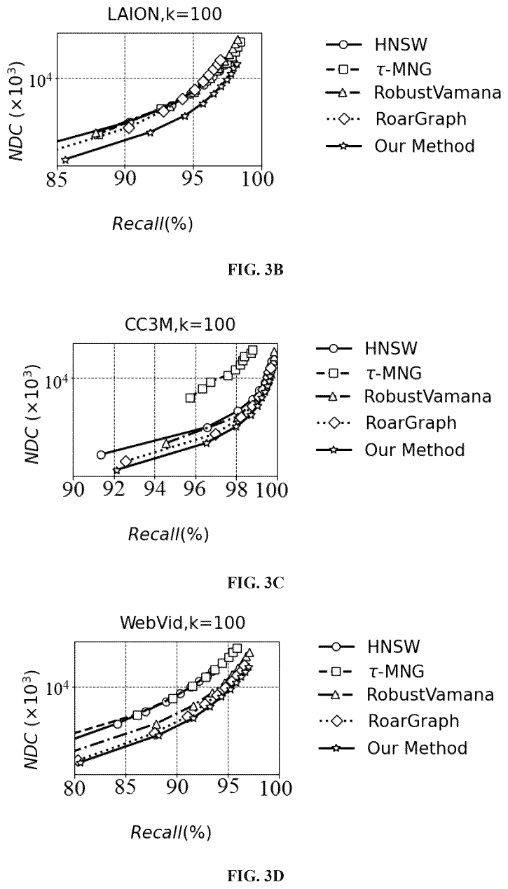

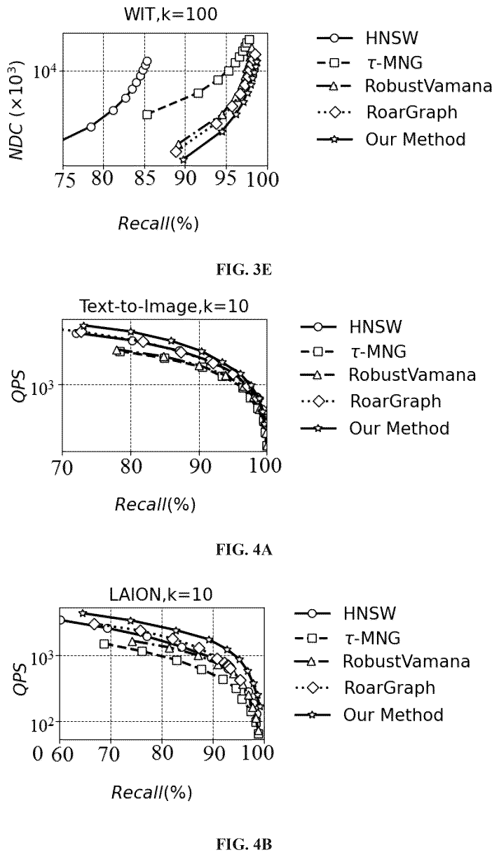

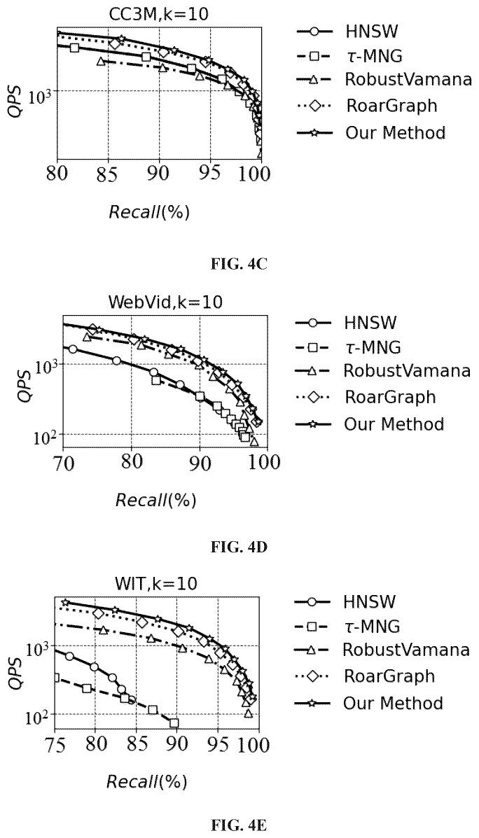

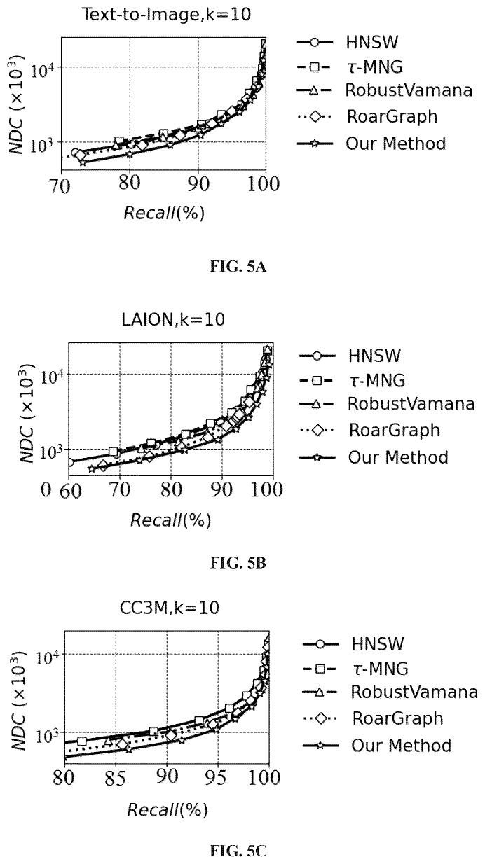

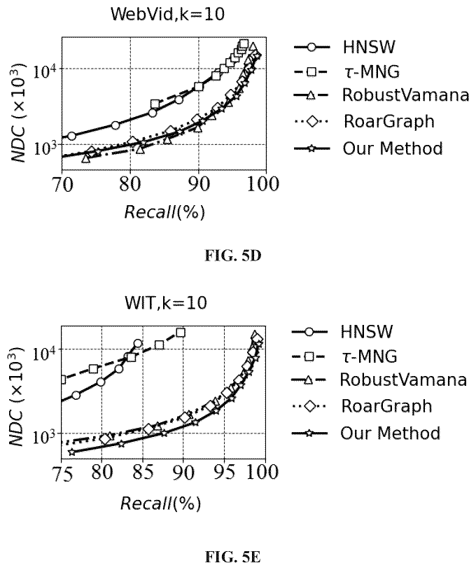

Description of test results: As shown in FIGS. 2A-5E, in the test, search accuracy was evaluated by using recall rate @ 100 (shown in FIGS. 2A-2E and FIGS. 3A-3E) and recall rate @10 (shown in FIGS. 4A-4E and FIGS. 5A-5E), and search efficiency was evaluated by using queries per second (QPS) and the number of distance calculations (NDC). In graphs (shown in FIGS. 2A-2E and FIGS. 4A-4E) illustrating recall rate @k versus queries per second, curves in at the upper right indicate better performance. On the contrary, in graphs (shown in FIGS. 3A-3E and FIGS. 5A-5E) describing recall rate @k versus the number of distance calculations count, curves at the lower right indicate better performance. The test results show that the performance of the present disclosure on all data sets is superior to all baseline algorithms, with a better balance between recall rate @k and queries per second/the number of distance calculations, that is, shorter search delay and less the number of calculations under the same accuracy requirement, and more accurate search result with the same search delay or limited number of calculations.

What is claimed is:

1. An out-of-distribution vector retrieval method, comprising:
step (1), obtaining a base vector set and a query vector set, wherein the query vector set is out-of-distribution data relative to the base vector set;
step (2), finding several nearest query vectors within the query vector set for each base vector within the base vector set, and generating an anchor vector for each base vector based on the found query vectors, wherein all anchor vectors constitute an anchor vector set;
step (3), constructing a fusion graph based on the base vector set and the anchor vector set; and
step (4), obtaining and converting a query text entered by a user from a search engine into a to-be-queried vector, performing search on the fusion graph to obtain a base vector similar to the to-be-queried vector, and returning the obtained base vector as a query result.

2. The out-of-distribution vector retrieval method according to claim 1, wherein in step (2), a process of constructing the anchor vector set comprises:
step (2-1), with the base vector set X={x₁, . . . , x_{N}} containing N independent and identically distributed base vectors and the query vector set Q={q₁, . . . , q_{M}} containing M independent and identically distributed query vectors, for any base vector x of the base vector set X={x₁, . . . , x_{N}}, obtaining a set of C query neighbors of x in the query vector set Q as
$$GT ( x ) = \{ {q}_{1}^{x} , … , {q}_{C}^{x} \} ,$$
wherein C is a number of query neighbors required for constructing the anchor vector set; and
step (2-2), inputting the query neighbor set GT(x) corresponding to each base vector x into an aggregation function e(·) to obtain an anchor vector τ, wherein all anchor vectors constitute the anchor vector set T.

3. The out-of-distribution vector retrieval method according to claim 2, wherein in step (3), a process of constructing the fusion graph comprises:
step (3-1), constructing, based on the base vector set X, a base neighbor graph G*(V, E*) with a first out-degree upper limit of L, wherein each node v of V represents a base vector x, E* indicates a neighbor relationship between nodes; and for any two nodes vᵢ and vⱼ in the base neighbor graph G*(V, E*), evaluating a similarity between vᵢ and vⱼ by using a distance δ(xᵢ, xⱼ), wherein xᵢ is a base vector corresponding to the node vᵢ, and x is a base vector corresponding to the node vⱼ;
step (3-2), for each node v of the base neighbor graph G*(V, E*), obtaining a base neighbor N*(v) of the node v in G*(V, E*) as a candidate and reranking, wherein
the base neighbor N*(v) is a set of end points of directed edges with the node v as a starting point in G*(V, E*); and
the reranking comprises: for the node v and any one node vᵢ∈N*(v) of the base neighbor N*(v), evaluating a similarity between vᵢ and v by using a fusion distance of δ_{f}(vᵢ, v)=δ(xᵢ+ατᵢ, x+ατ) during the reranking, wherein a is a fusion weight parameter, xᵢ and τᵢ respectively are a base vector and an anchor vector corresponding to the node vᵢ, and x and t respectively are a base vector and an anchor vector corresponding to the node v; and
step (3-3), setting a second out-degree upper limit R, where R<L, for each node v, performing similarity ranking according to a fusion distance from the base neighbor N*(v), selecting nodes v* in a descending order according to similarity to attempt to establish edges, and establishing the edges when the nodes v* meet an occlusion rule, and stopping the selecting and the establishing the edges when a number of established edges is equal to R, to obtain a fusion neighbor N(v); and
obtaining the fusion graph G(V, E) after for all nodes in G*(V, E*), edges are established according to the occlusion rule, wherein
N(v) is a set of end points of directed edges with the node v as a starting point in the fusion graph G(V,E).

4. The out-of-distribution vector retrieval method according to claim 3, wherein in step (4), the performing search on the fusion graph to obtain the base vector similar to the to-be-queried vector comprises:
step (4-1), selecting P nodes from the fusion graph G(V, E) as entry points, and placing the P nodes in a candidate set H;
step (4-2), selecting a node v E H that is not accessed and is nearest to the to-be-queried vector q* from the candidate set H as a current access node, evaluating a similarity between v and q* by using a distance δ(x, q*), and placing a fusion neighbor N(v) of the current access node in the candidate set H, wherein x is a base vector corresponding to the current access node v;
wherein the to-be-queried vector q* and the query vector set Q are independent and identically distributed;
step (4-3), evaluating a similarity between any one node v of the candidate set H and q* by using the distance δ(x, q*), performing similarity ranking in a descending order on all nodes of the candidate set H based on the distance δ(x, q*), and deleting nodes with ranks greater than P from the candidate set H, wherein x is a base vector corresponding to the node v; and
step (4-4), repeating step (4-2) to step (4-3) until there is no node that is not accessed in the candidate set H, and selecting first k base vectors from the candidate set H as a result.

5. The out-of-distribution vector retrieval method according to claim 1, wherein the base vector set in step (1) is composed of vectors obtained by converting pictures or videos in an image library of the search engine, and the query vector set is composed of vectors obtained by converting the query text entered by the user from the search engine;
step (4) further comprises:
outputting, based on the base vector obtained in step (4), a picture or a video in the image library of the search engine corresponding to the base vector.

6. The out-of-distribution vector retrieval method according to claim 3, wherein
in the distance δ(xᵢ, xⱼ) and the fusion distance of (vᵢ, v)=δ(xᵢ+ατᵢ, x+ατ), δ is any one of following three distance metrics: Euclidean distance, cosine similarity, and an inner product.

7. An out-of-distribution vector retrieval device, configured to implement the out-of-distribution vector retrieval method according to claim 1, the retrieval device comprising:
an input module, configured to obtain the base vector set and the query vector set as an input, wherein the query vector set is the out-of-distribution data relative to the base vector set;
an anchor vector set construction module, configured to find several nearest query vectors within the query vector set for each base vector within the base vector set, and generate the anchor vector for each base vector based on the found query vectors, wherein all anchor vectors constitute the anchor vector set;
a fusion graph construction module, configured to construct the fusion graph based on the base vector set and the anchor vector set; and
a search result output module, configured to perform search on the fusion graph to obtain the base vector similar to the to-be-queried vector, and return the obtained base vector as the query result.

8. The out-of-distribution vector retrieval device according to claim 7, wherein the input module comprises:
a base vector set input module, configured to obtain the base vector set;
a query vector set input module, configured to obtain the query vector set; and
a query distribution difference discrimination module, configured to determine whether the query vector set is the out-of-distribution data or in-distribution data.

9. The out-of-distribution vector retrieval device according to claim 7, wherein in step (2), a process of constructing the anchor vector set comprises:
step (2-1), with the base vector set X={x₁, . . . , x_{N}} containing N independent and identically distributed base vectors and the query vector set Q={q₁, . . . , q_{M}} containing M independent and identically distributed query vectors, for any base vector x of the base vector set X={x₁, . . . , x_{N}}, obtaining a set of C query neighbors of x in the query vector set Q as
$$G T ( x ) = \{ {q}_{1}^{x} , … , {q}_{C}^{x} \} ,$$
wherein C is a number of query neighbors required for constructing the anchor vector set; and
step (2-2), inputting the query neighbor set GT(x) corresponding to each base vector x into an aggregation function e(·) to obtain an anchor vector t, wherein all anchor vectors constitute the anchor vector set T.

10. The out-of-distribution vector retrieval device according to claim 9, wherein in step (3), a process of constructing the fusion graph comprises:
step (3-1), constructing, based on the base vector set X, a base neighbor graph G*(V, E*) with a first out-degree upper limit of L, wherein each node v of V represents a base vector x, E* indicates a neighbor relationship between nodes; and for any two nodes vᵢ and vⱼ in the base neighbor graph G*(V, E*), evaluating a similarity between vᵢ and vⱼ by using a distance δ(xᵢ, xⱼ), wherein xᵢ is a base vector corresponding to the node vᵢ, and x, is a base vector corresponding to the node vⱼ;
step (3-2), for each node v of the base neighbor graph G*(V, E*), obtaining a base neighbor N*(v) of the node v in G*(V, E*) as a candidate and reranking, wherein
the base neighbor N*(v) is a set of end points of directed edges with the node v as a starting point in G*(V, E*); and
the reranking comprises: for the node v and any one node v∈N*(v) of the base neighbor N*(v), evaluating a similarity between vᵢ and v by using a fusion distance of δ_{f}(vᵢ, v)=δ(xᵢ+ατᵢ, x+ατ) during the reranking, wherein α is a fusion weight parameter, xᵢ and τᵢ respectively are a base vector and an anchor vector corresponding to the node vᵢ, and x and τ respectively are a base vector and an anchor vector corresponding to the node v; and
step (3-3), setting a second out-degree upper limit R, where R<L, for each node v, performing similarity ranking according to a fusion distance from the base neighbor N*(v), selecting nodes v* in a descending order according to similarity to attempt to establish edges, and establishing the edges when the nodes v* meet an occlusion rule, and stopping the selecting and the establishing the edges when a number of established edges is equal to R, to obtain a fusion neighbor N(v); and
obtaining the fusion graph G(V, E) after for all nodes in G*(V, E*), edges are established according to the occlusion rule, wherein
N(v) is a set of end points of directed edges with the node v as a starting point in the fusion graph G(V,E).

11. The out-of-distribution vector retrieval device according to claim 10, wherein in step (4), the performing search on the fusion graph to obtain the base vector similar to the to-be-queried vector comprises:
step (4-1), selecting P nodes from the fusion graph G(V, E) as entry points, and placing the P nodes in a candidate set H;
step (4-2), selecting a node v E H that is not accessed and is nearest to the to-be-queried vector q* from the candidate set H as a current access node, evaluating a similarity between v and q* by using a distance δ(x, q*), and placing a fusion neighbor N(v) of the current access node in the candidate set H, wherein x is a base vector corresponding to the current access node v;
wherein the to-be-queried vector q* and the query vector set Q are independent and identically distributed;
step (4-3), evaluating a similarity between any one node v of the candidate set H and q* by using the distance δ(x, q*), performing similarity ranking in a descending order on all nodes of the candidate set H based on the distance δ(x, q*), and deleting nodes with ranks greater than P from the candidate set H, wherein x is a base vector corresponding to the node v; and
step (4-4), repeating step (4-2) to step (4-3) until there is no node that is not accessed in the candidate set H, and selecting first k base vectors from the candidate set H as a result.

12. The out-of-distribution vector retrieval device according to claim 7, wherein
the base vector set in step (1) is composed of vectors obtained by converting pictures or videos in an image library of the search engine, and the query vector set is composed of vectors obtained by converting the query text entered by the user from the search engine;
step (4) further comprises:
outputting, based on the base vector obtained in step (4), a picture or a video in the image library of the search engine corresponding to the base vector.

13. The out-of-distribution vector retrieval device according to claim 10, wherein
in the distance δ(xᵢ, xⱼ) and the fusion distance δ_{f}(vᵢ, v)=δ(xᵢ+ατᵢ, x+ατ), δ is any one of following three distance metrics: Euclidean distance, cosine similarity, and an inner product.

14. The out-of-distribution vector retrieval device according to claim 9, wherein the input module comprises:
a base vector set input module, configured to obtain the base vector set;
a query vector set input module, configured to obtain the query vector set; and
a query distribution difference discrimination module, configured to determine whether the query vector set is the out-of-distribution data or in-distribution data.

15. The out-of-distribution vector retrieval device according to claim 10, wherein the input module comprises:
a base vector set input module, configured to obtain the base vector set;
a query vector set input module, configured to obtain the query vector set; and
a query distribution difference discrimination module, configured to determine whether the query vector set is the out-of-distribution data or in-distribution data.

16. The out-of-distribution vector retrieval device according to claim 11, wherein the input module comprises:
a base vector set input module, configured to obtain the base vector set;
a query vector set input module, configured to obtain the query vector set; and
a query distribution difference discrimination module, configured to determine whether the query vector set is the out-of-distribution data or in-distribution data.

17. The out-of-distribution vector retrieval device according to claim 12, wherein the input module comprises:
a base vector set input module, configured to obtain the base vector set;
a query vector set input module, configured to obtain the query vector set; and
a query distribution difference discrimination module, configured to determine whether the query vector set is the out-of-distribution data or in-distribution data.

18. The out-of-distribution vector retrieval device according to claim 13, wherein the input module comprises:
a base vector set input module, configured to obtain the base vector set;
a query vector set input module, configured to obtain the query vector set; and
a query distribution difference discrimination module, configured to determine whether the query vector set is the out-of-distribution data or in-distribution data.
